(19) United States
(12) Patent Application Publication
(10) Pub. No.: US 2014/0091623 A1
(43) Pub. Date: Apr. 3, 2014

(54) POWER SHARE CONTROLLER

(71) Applicants: Keith Shippy, Tempe, AZ (US); Jennifer Healey, San Jose, CA (US); Gustavo Domingo Yaguez, Cordoba (AR); Mark Price, Placitas, NM (US)

(72) Inventors: Keith Shippy, Tempe, AZ (US); Jennifer Healey, San Jose, CA (US); Gustavo Domingo Yaguez, Cordoba (AR); Mark Price, Placitas, NM (US)

(21) Appl. No.: 13/630,083

(22) Filed: Sep. 28, 2012

(51) Int. Cl. H02J 7/00

(52) U.S. Cl. CPC H02J 7/0065
USPC 307/31

(57) ABSTRACT

A battery input receives a power discharge from a first battery of a local device. A controllable charging circuit generates a charging signal based on the power discharge, a charge status of the first battery, a charge status of one or more second battery for at least one of one or more external devices, and a load balancing plan associated with the local device and at least one of the one or more external devices. A charging output to route the charging signal to at least one of the one or more external devices.

### BACKGROUND

As mobile devices continue to become more prevalent, users of electronic mobile devices may simultaneously carry multiple mobile electronic devices. Examples of such devices include, but are not limited to: smart phones, laptops, electronic tablets, ultrabooks, eBook readers, and/or the like. For example, some people carry more than one phone at a time, one for personal use and one for work. Each of these devices typically have their own batteries, each with disparate discharge times. A person may frequently encounter situations where one or two of their devices have fully or almost fully discharged batteries while other devices have almost fully charged batteries. Today, many devices are recharged using an external wall socket power source with a charger/transformer. An alternative master/slave method for some devices is to recharge from another powered device via a hardware connection such as a Universal Serial Bus (USB) connection. Although these solutions may be suitable under certain circumstances, there remains considerable room for improvement.

### BRIEF DESCRIPTION OF THE DRAWINGS

The various advantages of the embodiments of the present invention will become apparent to one skilled in the art by reading the following specification and appended claims, and by referencing the following drawings, in which:

FIGS. 1-3 are block diagrams of examples of power share controllers according to embodiments;

FIGS. 4-7 are system diagrams of examples of multiple devices employing power share controllers according to embodiments;

FIGS. 8-11 are flowcharts of examples of methods of operating a power share controller according to embodiments;

FIG. 12 is a block diagram of an example of a processor according to an embodiment; and

FIG. 13 is a block diagram of an example of a system according to an embodiment.

### DETAILED DESCRIPTION

Embodiments of the present invention may perform automatic load balancing of power between mobile devices.

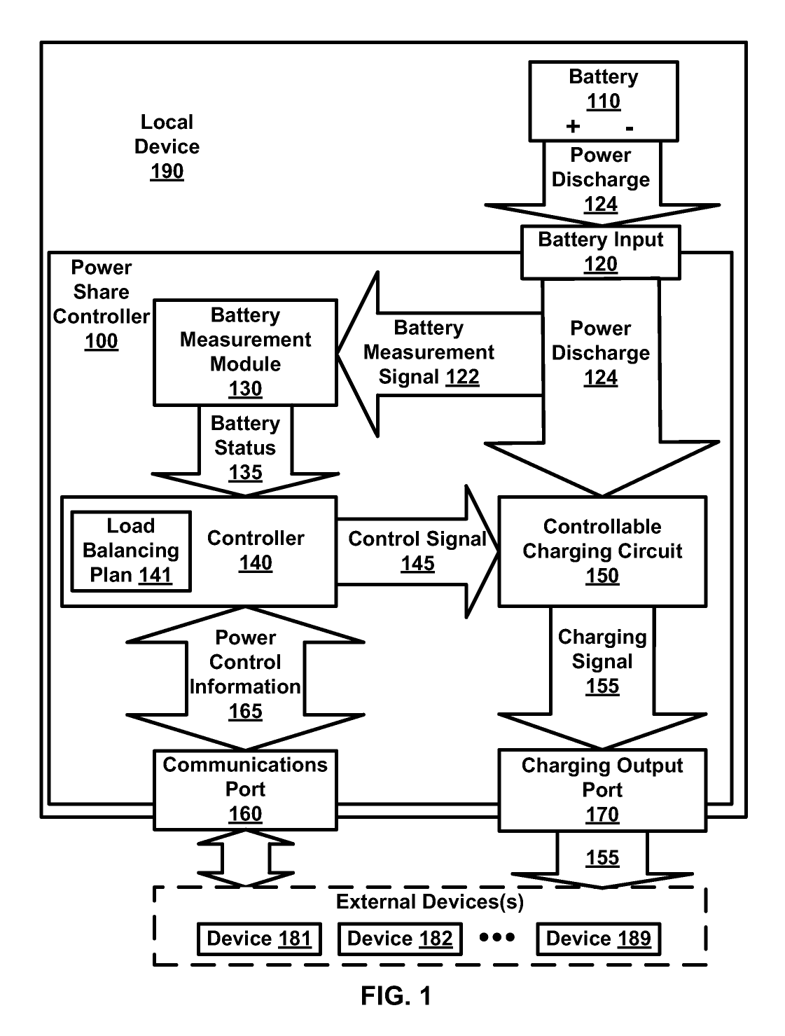

Turning now to FIG. 1, a block diagram of a power share controller 100 operating in a local device 190 is shown as per an aspect of an embodiment of the present invention. A battery input 120 may be configured to receive a power discharge 124 from a first battery 110 of a local device 190. The local device 190 may be a mobile device such as a mobile phone, a tablet computing device, a music player, an eReader, and/or the like. The battery 110 may be a device including one or more electrochemical cells that convert stored chemical energy into electrical energy. For example, batteries may include disposable batteries as well as rechargeable batteries, wherein either type of battery may be employed as a source for the power discharge 124. Rechargeable batteries may be configured to receive a charging signal. Examples of batteries that may be employed in present embodiments include zinc-carbon batteries, alkaline batteries, lead-acid batteries, nickel-cadmium (NiCd), nickel-zinc (NiZn), nickel metal hydride (NiMH), and lithium-ion (Li-ion) cells. Some batteries, such as the USBCELL manufactured by Moixa Energy Ltd. of London, UK, include electronics to enable the charging of cells through a USB connector. Batteries may operate with state-of-charge monitors and battery protection circuits to prevent damage on over and under discharge. It is envisioned that may different types of batteries may be employed in the present embodiments as long as they produce a power discharge 124 and/or receive a charge signal.

A controllable charging circuit 150 may be configured to generate a charging signal 155 based on the power discharge 124, a battery status 135 of the first battery 110, a charge status of one or more second batteries for at least one of one or more external devices 181-189, and a load balancing plan 141. The controllable charging circuit 150 may be an analog charging circuit, a digital charging circuit, and/or a combination analog/digital charging circuit.

The charging circuit 150 may charge at different rates. For example, the charging circuit 150 may charge at a relatively low rate. A typical slow rate charger is a trickle charger. Rapid charging circuits, on the other hand, may charge at a higher rate. Rapid charging circuits may use battery information such as changes in terminal voltage, temperature, etc. to determine when to stop charging before harmful overcharging or overheating occurs.

The load balancing plan 141 may be associated with the local device 190 and at least one of the one or more external devices 181-189. According to some of the various embodiments, the load balancing plan 141 may include rules that define how battery power is to be distributed between the local device 190 and the external devices 181-189. The load balancing plan 141 may be configured to enable an end user to increase the usefulness of their interconnected mobile devices. For example, the load balancing plan 141 may have priority settings that state that some mobile devices are to be charged to a specific level before other mobile devices receive a charge. The rules may be context specific. For example, if a user is traveling, it may be that the mobile phone gets priority over a laptop computer. If a user is in their office, the laptop may get priority over the mobile phone. Under some situations, the rules may state that all available power is to be transferred to a single device if that is the only device that is needed in the particular situation. Other rules may be more generic, like balance the power between all of the devices equally. Yet other rules may state a goal charge and/or charge rate for each mobile device to be apportioned over the mobile devices.

The load balancing plan 141 may be a single plan or may be a collection of one or more load balancing profiles. For example, the local device 190 or one or more of the external devices 181-189 may have separate load balancing profiles. Additionally, a user may have a load balancing profile. These profiles may be combined to generate the load balancing plan 141. In some cases, the user's load balancing profile may be used to combine and modify the individual load balancing profiles. An example device specific load balancing profile may specify a specific charging rate, a discharge plan, a minimum charge, a maximum charge, and/or the like. The user load balancing profile may specify a priority order of device readiness levels, a temporal device requirement plan, a combination thereof, and/or the like.

The charge status 135 may be determined by a battery measurement module 130. The charge status 135 may include information such as battery presence, battery temperature, battery charging rate, battery discharge rate, battery health, battery voltage, battery age, a combination thereof, and/or the like. The battery measurement module 130 may determine charge status 135 at least in part from a battery measurement signal 122 sampled from the power discharge 124. The battery measurement module 130 may have a high impedance input that is configured to measure voltage. The battery measurement module 130 may have a current measurement capability (such as letting the power discharge run through a fixed resistance and measuring the resultant voltage). In some embodiments, battery state information may be communicated in the power discharge signal 124 from the battery 110 and/or an external circuit to either the battery measurement module 130 and/or controller 140.

In some of the various embodiments, a controller 140 may control the controllable power circuit 150 to balance loads between at least two of the one or more external devices based on information originating from sources such as: the power discharge 124, the charge status of the first battery 135, the charge status of at least one of the one or more second battery from external devices 181-189, the load balancing plan 141, a combination thereof, and/or the like. The control may be in the form of a control signal 145. The control signal 145 may be configured to regulate controllable charging circuit 150. For example, the controllable charging circuit 150 may be configured to receive a digital control signal and/or an analog control signal.

A charging output port 170 may route the charging signal 155 to at least one of the one or more external devices 181-189. The routing may be implemented in numerous ways including the use of hard wiring and/or switching circuits. Switching circuits may be configured to provide a specific charging signal 155 to specific external devices 181-189. The switching circuits may be may be implemented, for example, through the controllable charging circuit 150, the charging output port 170 and/or at one or more of the external devices 181-189.

The charging output port 170 may employ one or more devices to route the charging signal 155 to at least one of the one or more external devices 181-189. Examples of these devices include: external power connector(s), a Universal Serial Bus connector, a power pad charger, a wireless resonant energy link, a DC-DC converter, a combination thereof, and/or the like.

In some of the various embodiments, the charging output port 170 may utilize a DC power connector to transfer power to external devices 181-189. A DC connector is an electrical connector that may supply direct current (DC) power. Any number of DC connector types may be used. The dimensions and arrangement of the DC connector may be chosen to prevent accidental interconnection of incompatible sources and loads between the local device 190 and the external devices 181-189. Example types of connectors include coaxial (barrel) connectors, automotive cigar lighter connectors, battery pack connectors, snap and lock connectors, molex connectors, SAE (Society of Automotive Engineers) connectors, a combination thereof, and/or the like.

The charging output port 170 may utilize a Universal Serial Bus (USB) connector. The USB connector is part of an industry USB standard that defines cables, connectors and communications protocols used in a bus for connection, communication and power supply between computers and electronic devices. USB has become commonplace on many mobile devices such as smartphones, PDAs, computing tablets, eReaders, and/or the like.

The USB 1.x and 2.0 specifications provide a 5 V supply on a single wire from which connected USB devices may draw power. The specification provides for no more than 5.25 V and no less than 4.75 V (5 V±5%) between the positive and negative bus power lines. For USB 3.0, the voltage supplied by low-powered hub ports is 4.45-5.25 V. A unit load is defined as 100 mA in USB 2.0, and 150 mA in USB 3.0. A device may draw up to 5 unit loads (500 mA) from a port in USB 2.0; 6 (900 mA) in USB 3.0. Two types of devices used with USB include: low-power devices and high-power devices. A low-power device may draw at most 1 unit load, with minimum operating voltage of 4.4 V in USB 2.0, and 4 V in USB 3.0. A high-power device may draw at most the maximum number of unit loads permitted by the standard. Devices may function initially at low-power but may request high-power.

The USB Battery Charging Specification defines USB charging ports. Charging ports may supply currents above 0.5 A without digital negotiation. A charging port supplies up to 500 mA at 5 V, up to the rated current at 3.6 V or more, and drop its output voltage if the portable device attempts to draw more than the rated current. The charger port may shut down if the load is too high. Charging ports may exist in two flavors: charging downstream ports (CDP) which support data transfers, and dedicated charging ports (DCP) that do not support data transfers. A portable device may recognize the type of USB port from the way the D+ and D− pins are connected. For example, on a dedicated charging port, the D+ and D− pins may be shorted. With charging downstream ports, current passing through the thin ground wire may interfere with high-speed data signals. Therefore, current draw may be limited to approximately 900 mA during high-speed data transfer. A dedicated charge port may have a rated current between 0.5 and 1.5 A. There may be no upper limit for the rated current of a charging downstream port, as long as the connector can handle the current (standard USB 2.0 A-connectors are rated at 1.5 A). USB charging ports may support simultaneous charge and sync by combining a charging port and a communication port into a single port.

The USB port may also be configured as a Sleep-and-charge USB port to charge electronic devices even when a mobile device is switched off. Normally when a mobile device is powered off, USB ports are powered down. This may prevent phones and other devices from being able to charge unless the device is powered on. Sleep-and-charge USB ports may remain powered even when the mobile device is off. The USB connector may be a standard USB connector, a mini-USB connector, a micro-USB connector, a custom USB port, and/or the like. The Micro-USB interface is commonly found on chargers for mobile phones. Many mobile phones may be able to use a USB port as a power port for battery charging.

In some of the various embodiments, the charging output port 170 may employ an inductive power charger. An inductive power charger may use magnetic induction to transfer energy between two devices. An inductive power charger may be configured to charge multiple devices with various power requirements. In some embodiments, the mobile device may use an external induction device connected to the mobile device to receive and/or send a charge between devices that are in local proximity of each other. Some inductive power chargers may be built directly into a mobile device or the battery of a mobile device. In some of the various embodiments, mobile devices may use modulation techniques to wirelessly communicate to each other through the induction signal. These communications may include power control information 165 as well as device authentication.

In some of the various embodiments, the charging output port 170 may employ a wireless resonant energy link (WREL). WREL is a form of wireless resonant energy transfer technology developed by Intel Corp. of Santa Clara, Calif. WREL relies on coupled electromagnetic resonators. At the receiving resonator's natural frequency, energy is absorbed efficiently. At a power source, power may be put into magnetic fields at a transmitting resonator. The receiving resonator may be tuned to efficiently absorb energy from the magnetic field, whereas nearby objects do not. A WREL may be configured to charge multiple devices with various power requirements. In some embodiments, the mobile device may use an external WREL device connected to the mobile device to receive and/or send a charge between devices. Some WREL chargers may be built directly into a mobile device or the battery of a mobile device. In some of the various embodiments, mobile devices may use modulation techniques to communicate to each other through the magnetic field. These communications may include power control information 165 as well as device authentication.

In some of the various embodiments, the charging output port 170 may employ a DC-DC converter. In yet other embodiments, a DC-DC converter may be employed external to the charging output port 170. A DC-to-DC converter is an electronic circuit that converts a source of direct current (DC) from one voltage level to another. Because some mobile devices may operate at different voltages, a DC-DC converter may be employed to develop compatibility between the mobile devices. Some DC-DC converters are linear converts which are sometimes used to lower voltage. Another type of DC-DC converter is a switched-mode converter that converts one DC voltage level to another by storing the input energy temporarily and then releasing that energy to the output at a different voltage. A third type of DC-DC converter is a magnetic converter, which periodically stores energy into and releases energy from a magnetic field in an inductor or a transformer by adjusting the duty cycle of the charging voltage. This type of converter may be applied to control the output voltage, though it may also be applied to control the input current, the output current, or maintain a constant power. Other types of DC-DC converters include capacitive and electromechanical converters.

The power share controller 100 may include a communications port 160 to communicate power control information 165 with at least one of the one or more of the external devices 181-189. The power control information 165 may include information that the controller 140 may use to balance power sharing among connected mobile devices. Examples of power control information 165 include one or more of the charge status of the first battery, the charge status of the one or more second battery, and/or the load balancing plan 141. In some embodiments, the communications port may be unidirectional, in which case the power control information 165 may include information from external sources external to the controller 140 such as external devices 181-189. In other embodiments, communications port may be bi-directional or multi-directional, in which case the power control information 165 may include information from local and external sources.

In some of the various embodiments, the system may be configured to support a stationary charging environment such as in a desktop charging configuration. In such a configuration, the system may derive its power signal from a source such as an AC power source. Alternatively, the power signal may derive the power signal from a battery system such as an uninterruptable power supply. The system may then charge multiple devices on the desktop. The controller may employ at least one load balancing profile to balance loads between the external devices being charges as described earlier.

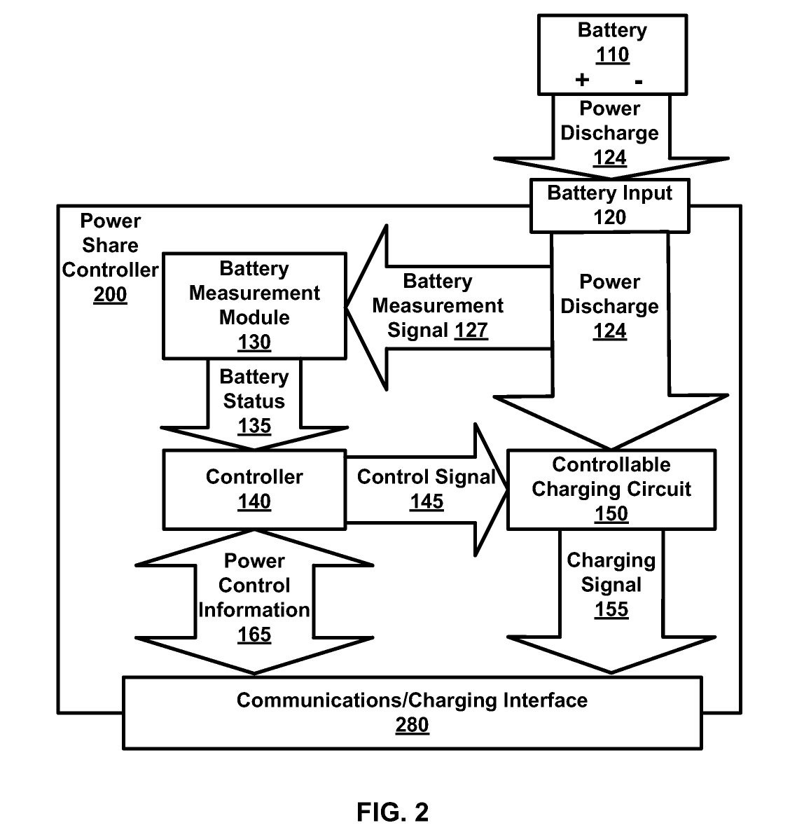

According to some of the various embodiments, combinations of the battery input port 120, communications port 160 and charging output port 170 may be combined. As described in this disclosure, communications may sometimes be effectuated over the charging signal and/or the power discharge signal 124. For example, FIG. 2 shows a power share controller 200 where the communications and charging functions are integrated into a communications/charging interface 280.

In some of the various embodiments, the controller may authenticate at least one of the one or more external devices 181-189. Authentication is the act of confirming he truth of an attribute of a datum or entity. In these embodiments, authentication may be used to identify device(s) and verify that the device(s) are who they report themselves to be. A party such as the owner of one of the one or more external devices 181-189, a corporate IT department, and/or the like may determine which of the devices 181-189 may authenticate with each other. The system may then use authentication to prevent unauthorized power draw from unapproved devices. Authentication may use one or more factors for identification. Example factors include something an authorized device knows, has, and/or is. Each authentication factor may cover a range of elements used to authenticate or verify a devices identity prior to being granted authority to operate in the battery load balancing operations. In the present embodiments, the mobile devices may employ a public-key infrastructure to cryptographically guarantee that a message originates from a particular mobile device. This may be used by having devices pass to each other electronic signatures using public and/or private keys.

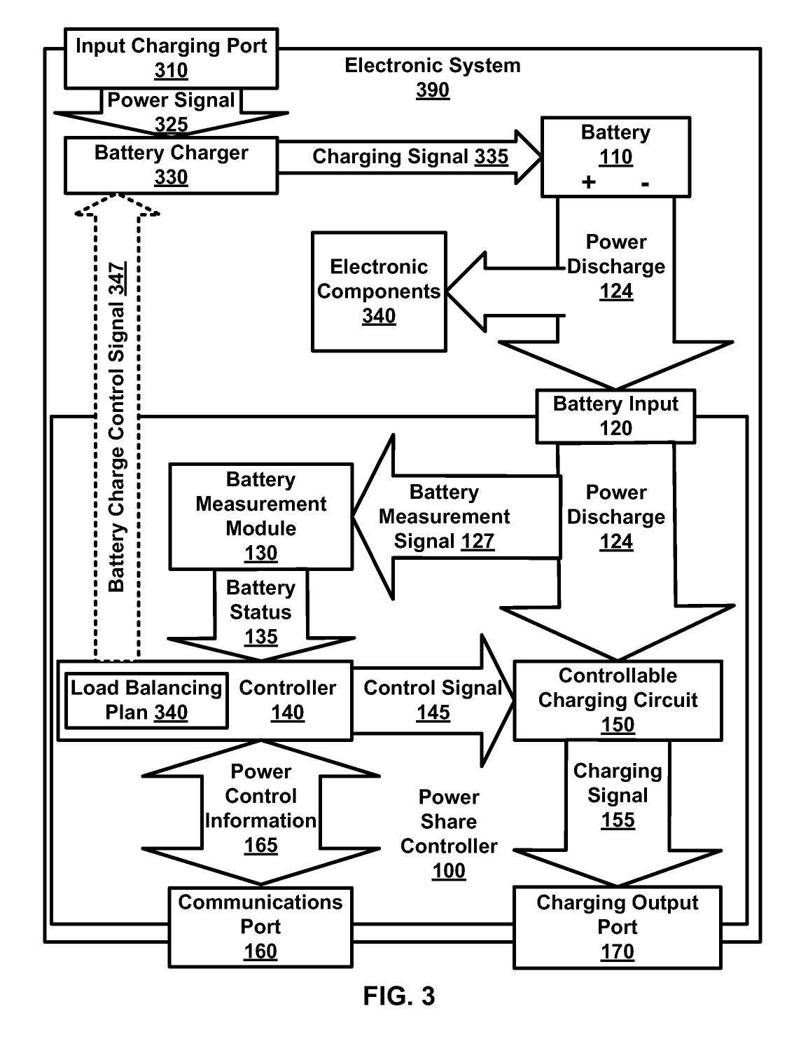

Example FIG. 3 is a block diagram of an electronic system 390 that includes the power share controller 100 or the like. In addition to the power share controller 100 as previously described, this example system includes an input charging port 310, and/or a battery charger 330, wherein the illustrated electronic system 390 may be, for example, a mobile device.

The input charging port 310 may be configured to receive a power signal 325 from a power source. The power signal 325 may originate from an external power source. The external power source may include a power adapter, an external battery, a generator, and/or the like. In some embodiments, the external battery may be from another electronic system such as a mobile device.

The battery charger 330 may convert the power signal, if necessary to a charging signal 335 configured to charge the battery 110. According to some of the various embodiments, battery charger 330 may be controlled by a battery charge control signal 347 originating from controller 140. The battery charge control signal 347 may enable the system 390 to regulate how and/or when the power signal 325 is converted to charging signal 335. In yet other embodiments, a battery charge control signal may be communicated to the battery charger through power signal 330. In some embodiments, the battery charger 330 may pass the power signal 325 through as the charging signal 335. This and other similar configurations may enable power share controller 100 to regulate battery balancing of electronic system 390.

Battery 110 may be configured to operate electronic components 340 specific to the electronic system 390. For example, the electronic components 340 may include displays, CPU(s), memory, audio drivers, and/the like.

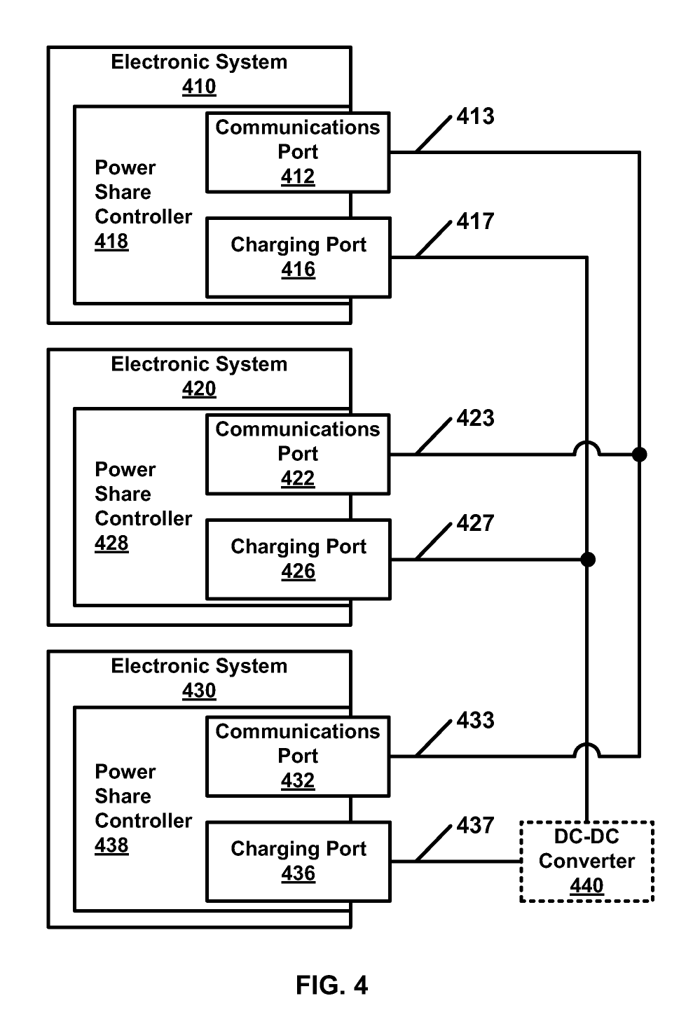

Example FIG. 4 is a system diagram of multiple devices 410, 420 and 430 employing power share controllers 418, 428 and 438, respectively as per an aspect of an embodiment of the present invention. As illustrated in this example embodiment, each of the power share controllers 418, 428, and 438 has a communications port 412, 422 and 432, respectively and a charging port 416, 426 and 436, respectively. The communications ports 412, 422 and 432 may be interconnected via communication lines 413, 423 and 433, respectively. Each of the charging ports may be interconnected via charging lines 417, 427 and 437, respectively. An example DC-DC converter 440 is shown in-line with the charging line 437 to adapt the voltage between charging ports 426 and 416 with the charging port 436. The power share controllers 418, 428, and 438 may be configured to communicate with each other to balance the battery loads between electronic systems 410, 420 and 430.

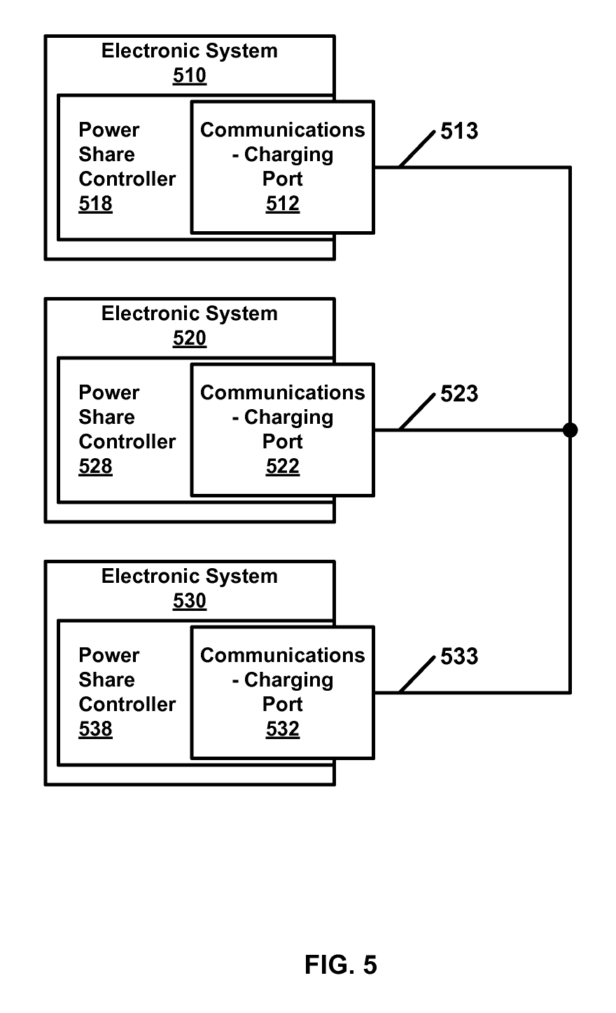

Example FIG. 5 is a system diagram of multiple devices 510, 520, and 530 employing power share controllers 518, 528, and 538, respectively as per an aspect of an embodiment of the present invention. As illustrated in this example embodiment, each of the power share controllers 518, 528, and 538 has an integrated communications-charging port 512, 522 and 532, respectively interconnected via communication-charging lines 513, 523 and 533, respectively. The power share controllers 518, 528, and 538 may be configured to communicate with each other to balance the battery loads between electronic systems 510, 520 and 530.

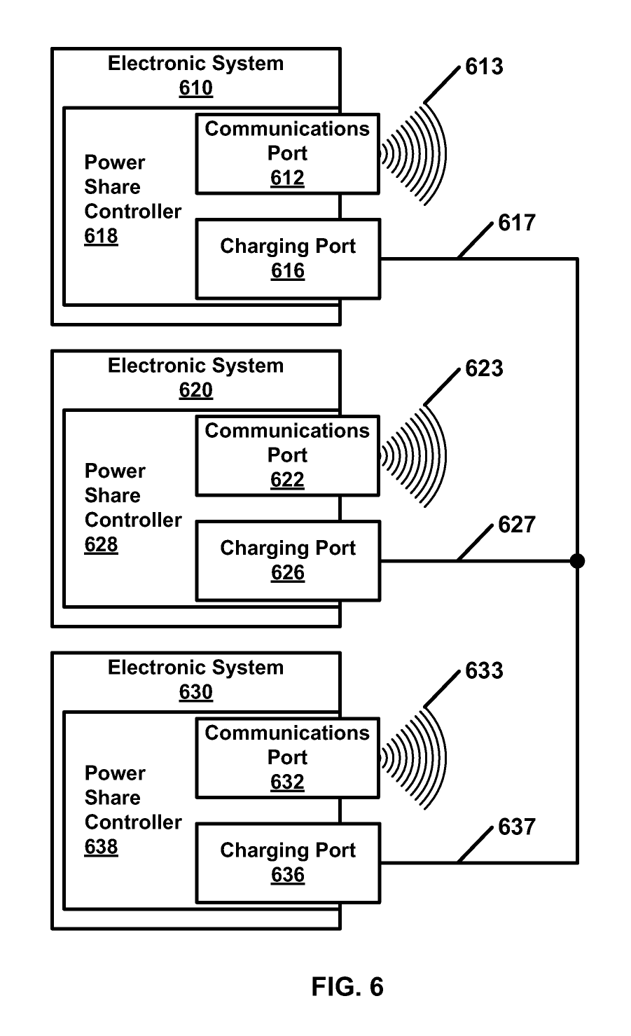

Example FIG. 6 is a system diagram of multiple devices 610, 620 and 630 employing power share controllers 618, 628 and 638, respectively as per an aspect of an embodiment of the present invention. As illustrated in this example embodiment, each of the power share controllers 618, 628, and 638 has a wireless communications port 612, 622 and 632, respectively and a charging port 616, 626 and 636, respectively. The wireless communications ports 612, 622 and 632, respectively may be interconnected via wireless communications signals 613, 623 and 633, respectively. Each of the charging ports may be interconnected via charging lines 617, 627 and 637, respectively. The power share controllers 618, 628, and 638 may be configured to communicate with each other to balance the battery loads between electronic systems 610, 620 and 630.

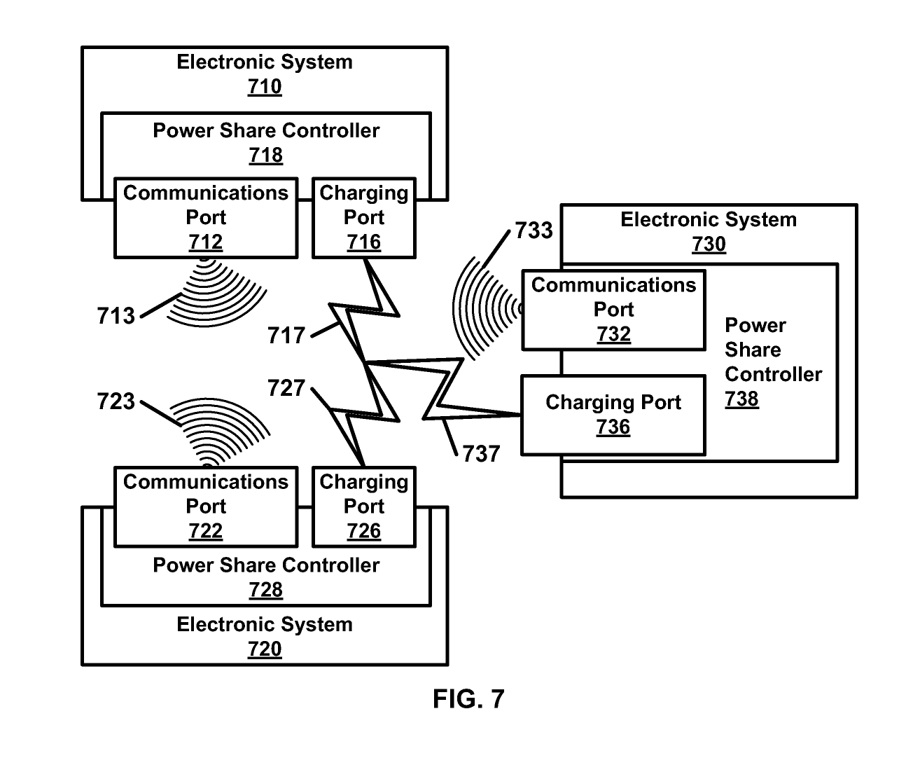

Example FIG. 7 is a system diagram of multiple devices 710, 720 and 730 employing power share controllers 718, 728 and 738, respectively as per an aspect of an embodiment of the present invention. As illustrated in this example embodiment, each of the power share controllers 718, 728, and 738 has a wireless communications port 712, 722 and 732, respectively, and a wireless charging port 716, 726 and 736, respectively. The wireless communications ports 712, 722 and 732 may be interconnected via wireless communications signals 713, 723 and 733, respectively. Each of the wireless charging ports may be interconnected via wireless charging signals 717, 727 and 737, respectively. The power share controllers 718, 728, and 738 may be configured to communicate with each other to balance the battery loads between electronic systems 710, 720 and 730.

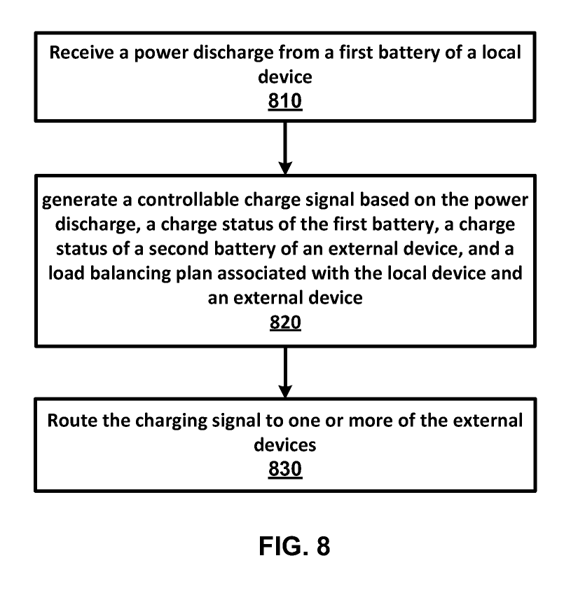

Example FIG. 8 shows a method of operating a power share controller as per an aspect of an embodiment of the present invention. At processing block 810, a power discharge may be received from a first battery of a local device. The local device may be a mobile device such as a smart phone, tablet computer, laptop, audio player and/or the like. The local device may receive a charge status from a monitor of the first battery. In some embodiments, the charge status may be determined by monitoring the voltage or current of the first battery.

The local device may be configured to interconnect with other mobile devices external to the local device. The external device(s) may be configured to share battery status information. A controllable charge signal may be generating based on the power discharge, a charge status of the first battery, battery charge status of external device(s), a load balancing plan and/or the like associated with the local device and an external device(s) at block 820. The controllable charge signal may be routed to one or more external devices at block 830 through a power sharing linkage.

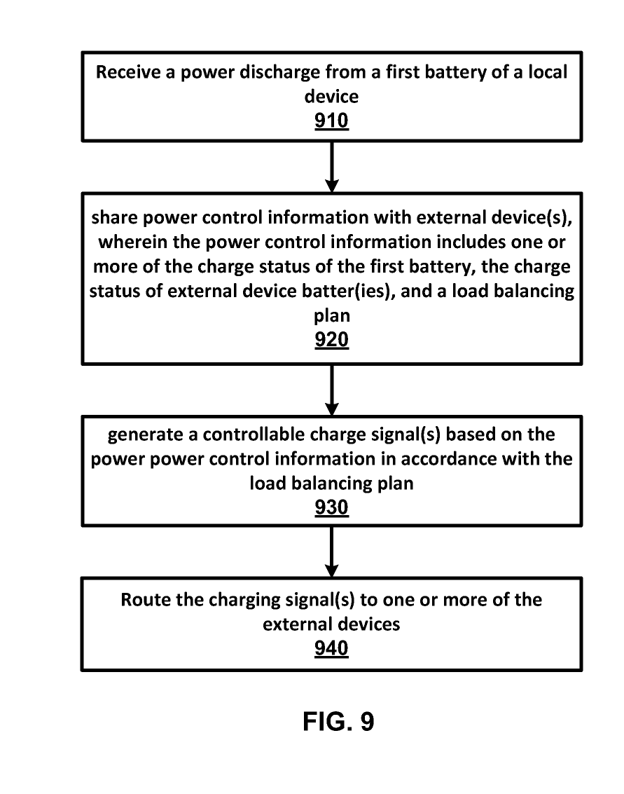

Example FIG. 9 shows another method of operating a power share controller as per an aspect of an embodiment of the present invention. At block 910, a power discharge may be received from a first battery of a local device. The local device may be a mobile device configured to connect communicatively and share power with external device(s). The local device may share power control information with the external device(s) at block 920. The power control information may include one or more of the charge status of the first battery, the battery charge status of the external device(s), a load balancing plan, and/or the like associated with the local device and external device(s). The power control information may be communicated with the external device(s) on a periodic basis. A controllable charge signal may be generating based on the power control information in accordance with the load balancing plan at block 930. At block 940, the charge signal may be routed to one or more of the external devices. The charge signal may be routed through one or more of an external power connector, a Universal Serial Bus connector, an inductive power charger, a wireless resonant energy link, a DC-DC converter, and/or the like.

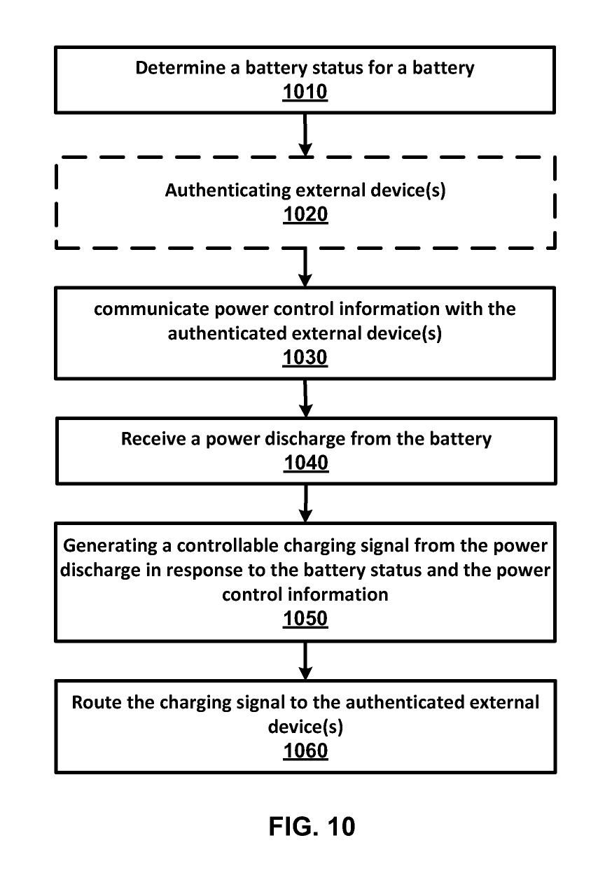

Example FIG. 10 shows another method of operating a power share controller as per an aspect of an embodiment of the present invention where external devices are authenticated. At block 1010, a battery status may be determined for a battery associated with a local device. The status may be determined using physical measurements of the battery such as output voltage, current draw, temperatures, and/or the like.

External devices desiring to share power may be authenticated at block 1020. Authentication may be provided using public key encryption. Tokens may be used by shared power controllers in mobile devices to identify themselves to other shared power controllers. The tokens may be shared secrets such as passwords and symmetric cryptographic keys that devices pass to each other to prove identity. Other authentication techniques that may be implemented in embodiments include asymmetric cryptographic keys which have a private key (which only one device knows) and a related public key, which can be made publicly available through a public key certificate issued by a Public Key Infrastructure (PKI). Other authentication mechanisms known in the art may also be used in various embodiments.

At block 1030, power control information may be communicated with at least one authenticated external device. The power control information may include load balancing profiles and plans as well as battery status information for connected and authenticated devices. A power discharge may be received from the local battery at block 1040. A controllable charging signal may be generated from the power discharge in response to the battery status and the power control information at block 1050. The charging signal may accordingly be routed to at least one of the authenticated external device(s) at block 1060.

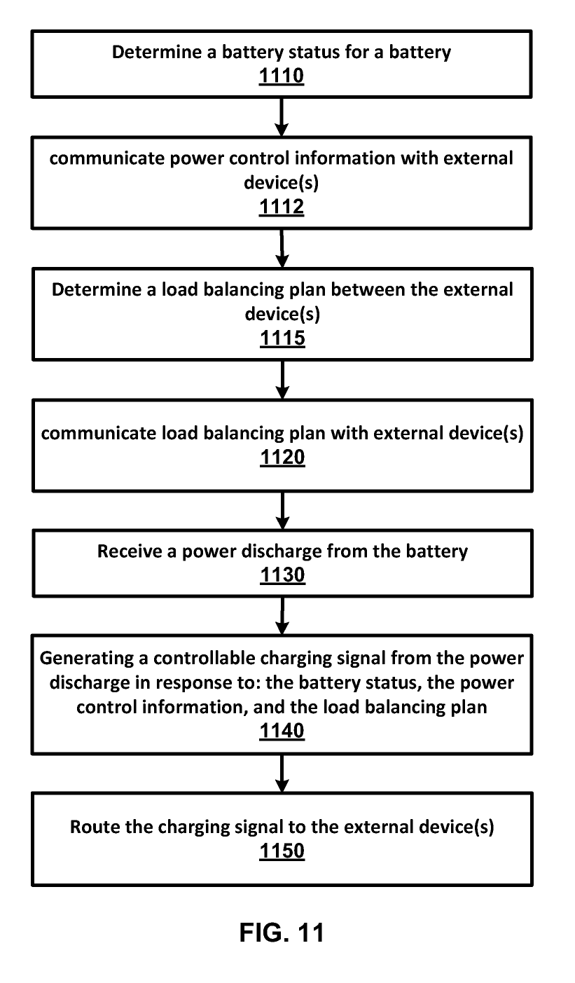

Example FIG. 11 shows another method of operating a power share controller as per an aspect of an embodiment of the present invention. A battery status for a local battery may be determined at block 1110. Power control information may be communicated among connected devices at block 1112. The power control information may include the battery status of the local battery as well as other power information from the local device and/or the external device(s). A load balancing plan may be formed at block 1115 using the communicated power control information and communicated to connected external devices at block 1120. In some embodiments, the plan may be formed by a local device. In other embodiments, the plan may be formed by one of the external devices. In yet another embodiment, the plan may be formed by one or more of the local and/or external devices.

A power discharge signal may be received from the battery at block 1130. Illustrated block 1140 generates one or more controllable charge signals in response to at least one of the battery status, the power control information, the load balancing plan, a combination thereof, and/or the like. The one or more charge signals may be routed to a corresponding external device(s) in accordance with the load balancing plan at block 1150.

Additionally, the local device may receive, as part of the power balancing process, a charge signal originating from one or more external device(s) where the charge signal is routed from the external device to the first battery in accordance with the load balancing plan.

Some of the various embodiments may be executed in part by one or more processors executing instructions residing on a non-transitory machine-readable medium. The processors may control the controllable charging circuit according to a load balancing plan in response to at least one of the battery status, the power control information, a combination thereof, and/or the like.

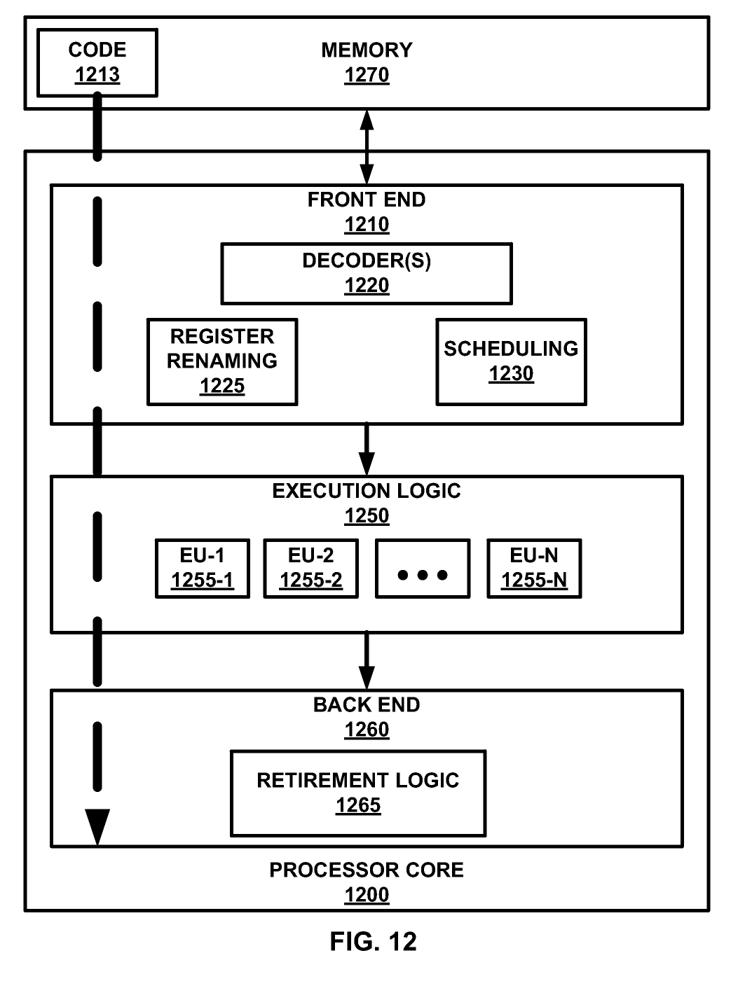

FIG. 12 illustrates a processor core 1200 according to one embodiment. The processor core 1200 may be the core for any type of processor, such as a micro-processor, an embedded processor, a digital signal processor (DSP), a network processor, or other device to execute code. Although only one processor core 1200 is illustrated in FIG. 12, a processing element may alternatively include more than one of the processor core 1200 illustrated in FIG. 12. The processor core 1200 may be a single-threaded core or, for at least one embodiment, the processor core 1200 may be multithreaded in that it may include more than one hardware thread context (or “logical processor”) per core.

FIG. 12 also illustrates a memory 1270 coupled to the processor 1200. The memory 1270 may be any of a wide variety of memories (including various layers of memory hierarchy) as are known or otherwise available to those of skill in the art. The memory 1270 may include one or more code 1213 instruction(s) to be executed by the processor 1200 core, wherein the code 1213 may implement the logic architecture 100 (FIG. 1), already discussed. The processor core 1200 follows a program sequence of instructions indicated by the code 1213. Each instruction may enter a front end portion 1210 and be processed by one or more decoders 1220. The decoder 1220 may generate as its output a micro operation such as a fixed width micro operation in a predefined format, or may generate other instructions, microinstructions, or control signals which reflect the original code instruction. The illustrated front end 1210 also includes register renaming logic 1225 and scheduling logic 1230, which generally allocate resources and queue the operation corresponding to the convert instruction for execution.

The processor 1200 is shown including execution logic 1250 having a set of execution units 1255-1 through 1255-N. Some embodiments may include a number of execution units dedicated to specific functions or sets of functions. Other embodiments may include only one execution unit or one execution unit that can perform a particular function. The illustrated execution logic 1250 performs the operations specified by code instructions.

After completion of execution of the operations specified by the code instructions, back end logic 1260 retires the instructions of the code 1213. In one embodiment, the processor 1200 allows out of order execution but requires in order retirement of instructions. Retirement logic 1265 may take a variety of forms as known to those of skill in the art (e.g., re-order buffers or the like). In this manner, the processor core 1200 is transformed during execution of the code 1213, at least in terms of the output generated by the decoder, the hardware registers and tables utilized by the register renaming logic 1225, and any registers (not shown) modified by the execution logic 1250.

Although not illustrated in FIG. 12, a processing element may include other elements on chip with the processor core 1200. For example, a processing element may include memory control logic along with the processor core 1200. The processing element may include I/O control logic and/or may include I/O control logic integrated with memory control logic. The processing element may also include one or more caches.

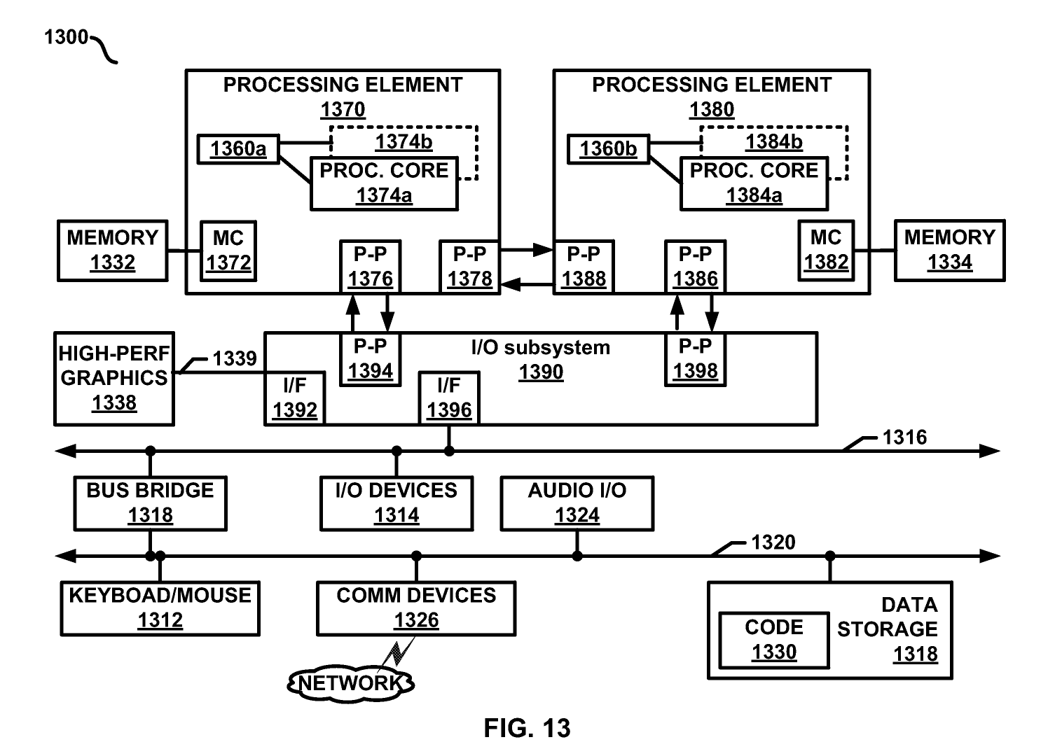

Referring now to FIG. 13, shown is a block diagram of a system embodiment 1000 in accordance with an embodiment of the present invention. Shown in FIG. 13 is a multiprocessor system 1300 that includes a first processing element 1370 and a second processing element 1380. While two processing elements 1370 and 1380 are shown, it is to be understood that an embodiment of system 1300 may also include only one such processing element.

System 1300 is illustrated as a point-to-point interconnect system, wherein the first processing element 1370 and second processing element 1380 are coupled via a point-to-point interconnect 1350. It should be understood that any or all of the interconnects illustrated in FIG. 13 may be implemented as a multi-drop bus rather than point-to-point interconnect.

As shown in FIG. 13, each of processing elements 1370 and 1380 may be multicore processors, including first and second processor cores (i.e., processor cores 1374a and 1374b and processor cores 1384a and 1384b). Such cores 1374, 1374b, 1384a, 1384b may be configured to execute instruction code in a manner similar to that discussed above in connection with FIG. 13.

Each processing element 1370, 1380 may include at least one shared cache 1360. The shared cache 1360a, 1360b may store data (e.g., instructions) that are utilized by one or more components of the processor, such as the cores 1374a, 1374b and 1384a, 1384b, respectively. For example, the shared cache may locally cache data stored in a memory 1332, 1334 for faster access by components of the processor. In one or more embodiments, the shared cache may include one or more mid-level caches, such as level 2 (L2), level 3 (L3), level 4 (L4), or other levels of cache, a last level cache (LLC), and/or combinations thereof.

While shown with only two processing elements 1370, 1380, it is to be understood that the scope of the present invention is not so limited. In other embodiments, one or more additional processing elements may be present in a given processor. Alternatively, one or more of processing elements 1370, 1380 may be an element other than a processor, such as an accelerator or a field programmable gate array. For example, additional processing element(s) may include additional processors(s) that are the same as a first processor 1370, additional processor(s) that are heterogeneous or asymmetric to processor a first processor 1370, accelerators (such as, e.g., graphics accelerators or digital signal processing (DSP) units), field programmable gate arrays, or any other processing element. There can be a variety of differences between the processing elements 1370, 1380 in terms of a spectrum of metrics of merit including architectural, microarchitectural, thermal, power consumption characteristics, and the like. These differences may effectively manifest themselves as asymmetry and heterogeneity amongst the processing elements 1370, 1380. For at least one embodiment, the various processing elements 1370, 1380 may reside in the same die package.

First processing element 1370 may further include memory controller logic (MC) 1372 and point-to-point (P-P) interfaces 1376 and 1378. Similarly, second processing element 1380 may include a MC 1382 and P-P interfaces 1386 and 1388. As shown in FIG. 6, MC's 1372 and 1382 couple the processors to respective memories, namely a memory 1332 and a memory 1334, which may be portions of main memory locally attached to the respective processors. While the MC logic 1372 and 1382 is illustrated as integrated into the processing elements 1370, 1380, for alternative embodiments the MC logic may be discrete logic outside the processing elements 1370, 1380 rather than integrated therein.

The first processing element 1370 and the second processing element 1380 may be coupled to an I/O subsystem 1390 via P-P interconnects 1376, 1386 and 1384, respectively. As shown in FIG. 13, the I/O subsystem 1390 includes P-P interfaces 1394 and 1398. Furthermore, I/O subsystem 1390 includes an interface 1392 to couple I/O subsystem 1390 with a high performance graphics engine 1338. In one embodiment, bus 1349 may be used to couple graphics engine 1338 to I/O subsystem 1390. Alternately, a point-to-point interconnect 1339 may couple these components.

In turn, I/O subsystem 1390 may be coupled to a first bus 1316 via an interface 1396. In one embodiment, first bus 1316 may be a Peripheral Component Interconnect (PCI) bus, or a bus such as a PCI Express bus or another third generation I/O interconnect bus, although the scope of the present invention is not so limited.

As shown in FIG. 13, various I/O devices 1314 such as battery measurement module 130 (FIG. 1) and/or controllable charging circuit 150 (FIG. 1) may be coupled to the first bus 1316, along with a bus bridge 1318 which may couple the first bus 1316 to a second bus 1310. In one embodiment, the second bus 1320 may be a low pin count (LPC) bus. Various devices may be coupled to the second bus 1320 including, for example, a keyboard/mouse 1312, communication device(s) 1326 (which may in turn be in communication with a computer network and/or other devices such as 710, 730 and/or 720), and a data storage unit 1318 such as a disk drive or other mass storage device which may include code 1330, in one embodiment. The code 1330 may include instructions for performing embodiments of one or more of the methods described above. Thus, the illustrated code 1330 may implement the logic architecture 100 (FIG. 1) and could be similar to the code 1213 (FIG. 12), already discussed. Further, an audio I/O 1324 may be coupled to second bus 1320.

Note that other embodiments are contemplated. For example, instead of the point-to-point architecture of FIG. 13, a system may implement a multi-drop bus or another such communication topology. Also, the elements of FIG. 13 may alternatively be partitioned using more or fewer integrated chips than shown in FIG. 13.

Examples may therefore include a system having an input charging port to receive a power signal, a battery charger configured to generate a first charging signal from the power signal, a battery to receive the charging signal, and power a multitude of electronic components, and a power share controller including: a battery input to receive a power discharge from the battery, a controllable power circuit to generate a second charging signal from the power discharge, a charging output to route the second charging signal to one or more external devices, a battery measurement module to determine a battery status for the battery, a communications port to communicate power control information with at least one of the one or more external devices, and a controller to control the controllable power circuit employing the battery status, and the power control information.

Additionally, the charging output of the system example may include one or more of an external power connector, a Universal Serial Bus connector, an inductive power charger, a wireless resonant energy link.

Additionally, the charging output of the system example may route the charging signal to a DC-DC converter.

Moreover, the controller of the system example may authenticate at least one of the one or more external devices.

In addition, the controller of the system example may balance loads between at least two of the one or more external devices.

In addition, the controller of the system example may employ at least one load balancing profile.

Moreover, the charging output and the communications port of the system example may be integrated.

Additionally, the power signal of the system example may derive from an AC power source and the controller may employ at least one load balancing profile to balance loads between at least two of the one or more external devices.

Examples may also include an apparatus, having a battery input to receive a power discharge from a first battery of a local device, a controllable charging circuit to generate a charging signal based on the power discharge, a charge status of the first battery, a charge status of one or more second battery for at least one of one or more external devices, and a load balancing plan associated with the local device and at least one of the one or more external devices, and a charging output to route the charging signal to at least one of the one or more external devices.

Additionally, the apparatus example may further include a controller to control the controllable power circuit based on the power discharge, the charge status of the first battery, the charge status of at least one of the one or more second battery, and the load balancing plan associated with the local device and at least one of the one or more external devices.

Additionally, the apparatus example may further including a communications port to communicate power control information with at least one of the one or more external devices, wherein the power control information includes one or more of the charge status of the first battery, the charge status of the one or more second battery, and the load balancing plan.

Moreover, the apparatus example may further include a battery measurement module to determine the battery status for the first battery.

In addition, the charging output of the apparatus example may include one or more of an external power connector, a USB connector, Universal Serial Bus connector, an inductive power charger, a wireless resonant energy link, and a DC-DC converter.

In addition, the controller of the apparatus example may further authenticate at least one of the one or more external devices.

Moreover, the controller of the apparatus example may balance loads between at least two of the one or more external devices.

Additionally, the controller of the apparatus example may employ at least one load balancing profile.

Additionally, one or more of the charging output, the battery input, and the communications port of the apparatus example may be integrated.

Examples may also include a method that involves receiving a power discharge from a first battery of a local device, generating a controllable charge signal based on the power discharge, a charge status of the first battery, a charge status of a second battery of an external device, and a load balancing plan associated with the local device and an external device, and routing the charge signal to the external device.

Additionally, the method example may further include sharing power control information with the external device, wherein the power control information includes one or more of the charge status of the first battery, the charge status of the second battery, and the load balancing plan.

Additionally, the power control information of the method example may be communicated with the external device on a periodic basis.

Moreover, the charge signal of the method example may be routed through one or more of an external power connector, a Universal Serial Bus connector, an inductive power charger, a wireless resonant energy link, and a DC-DC converter.

In addition, the method example may further include authenticating the external device.

In addition, the method example may further include generating a plurality of controllable charge signals, and routing the plurality of charge signals to a corresponding plurality of external devices in accordance with the load balancing plan.

Moreover, the method example may further include receiving a charge signal from the external device, and routing the charge signal from the external device to the first battery in accordance with the load balancing plan.

Examples may also include a non-transitory computer readable medium comprising a set of instructions which, if executed by a processor cause a local device to perform any one of the aforementioned method examples.

While various embodiments have been described above, it should be understood that they have been presented by way of example, and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Thus, the present embodiments should not be limited by any of the above described exemplary embodiments. In particular, it should be noted that, for example purposes, the above explanation has focused on the example(s) of balancing power between mobile devices. However, one skilled in the art will recognize that embodiments of the invention could be used to balance power among non-mobile devices such as uninterruptable power supplies. Additionally, the above examples discuss transferring power between batteries. However, one skilled in the art will recognize that other devices such as external chargers, photovoltaic circuits, or the like may be used as part of the load balancing circuit. In this case, there may be a priority for charging multiple devices, even when one of the power sources are not battery based.

In this specification, “a” and “an” and similar phrases are to be interpreted as “at least one” and “one or more.” References to “an” embodiment in this disclosure are not necessarily to the same embodiment.

Many of the elements described in the disclosed embodiments may be implemented as modules. A module is defined here as an isolatable element that performs a defined function and has a defined interface to other elements. The modules described in this disclosure as well as the methods described with respect to FIGS. 8-11 may be implemented in hardware, a combination of hardware and software, firmware, wetware (i.e hardware with a biological element) or a combination thereof, all of which are behaviorally equivalent. For example, modules and/or methods may be implemented using computer hardware in combination with software routine(s) written in a computer language (such as C, C++, Fortran, Java, Basic, Matlab or the like) or a modeling/simulation program such as Simulink, Stateflow, GNU Octave, or LabVIEW MathScript. Additionally, it may be possible to implement modules using physical hardware that incorporates discrete or programmable analog, digital and/or quantum hardware. Examples of programmable hardware include: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. Finally, the above mentioned technologies may be used in combination to achieve the result of a functional module.

Some embodiments may employ processing hardware. Processing hardware may include one or more processors, computer equipment, embedded system, machines and/or the like. The processing hardware may be configured to execute instructions. The instructions may be stored on a machine-readable medium. According to some embodiments, the machine-readable medium (e.g. automated data medium) may be a medium configured to store data in a machine-readable format that may be accessed by an automated sensing device. Examples of machine-readable media include: magnetic disks, cards, tapes, and drums, punched cards and paper tapes, optical disks, barcodes, magnetic ink characters and/or the like.

In addition, it should be understood that any figures that highlight any functionality and/or advantages, are presented for example purposes only. The disclosed architecture is sufficiently flexible and configurable, such that it may be utilized in ways other than that shown. For example, the steps listed in any flowchart may be re-ordered or only optionally used in some embodiments.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope in any way.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Embodiments of the present invention are applicable for use with all types of semiconductor integrated circuit (“IC”) chips. Examples of these IC chips include but are not limited to processors, controllers, chipset components, programmable logic arrays (PLAs), memory chips, network chips, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments of the present invention are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments of the invention. Further, arrangements may be shown in block diagram form in order to avoid obscuring embodiments of the invention, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments of the invention, it should be apparent to one skilled in the art that embodiments of the invention can be practiced without, or with variation of, these specific details. The description is thus to be regarded as illustrative instead of limiting.

Some embodiments may be implemented, for example, using a machine or tangible computer-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

Those skilled in the art will appreciate from the foregoing description that the broad techniques of the embodiments of the present invention can be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

We claim:

1. A system, comprising:
an input charging port to receive a power signal;
a battery charger configured to generate a first charging signal from the power signal;
a battery to receive the charging signal, and power a multitude of electronic components; and
a power share controller including: a battery input to receive a power discharge from the battery, a controllable power circuit to generate a second charging signal from the power discharge, a charging output to route the second charging signal to one or more external devices, a battery measurement module to determine a battery status for the battery, a communications port to communicate power control information with at least one of the one or more external devices, and a controller to control the controllable power circuit employing the battery status, and the power control information.

2. The system according to claim 1, wherein the charging output includes one or more of an external power connector, a Universal Serial Bus connector, an inductive power charger, a wireless resonant energy link.

3. The system according to claim 1, wherein the charging output routes the charging signal to a DC-DC converter.

4. The system according to claim 1, wherein the controller authenticates at least one of the one or more external devices.

5. The system according to claim 1, wherein the controller balances loads between at least two of the one or more external devices.

6. The system according to claim 1, wherein the controller employs at least one load balancing profile.

7. The system according to claim 1, wherein the charging output and the communications port are integrated.

8. The system according to claim 1, wherein the power signal derives from an AC power source and the controller employs at least one load balancing profile to balance loads between at least two of the one or more external devices.

9. An apparatus, comprising:
a battery input to receive a power discharge from a first battery of a local device;
a controllable charging circuit to generate a charging signal based on the power discharge, a charge status of the first battery, a charge status of one or more second battery for at least one of one or more external devices, and a load balancing plan associated with the local device and at least one of the one or more external devices; and
a charging output to route the charging signal to at least one of the one or more external devices.

10. The apparatus according to claim 9, further including a controller to control the controllable power circuit based on the power discharge, the charge status of the first battery, the charge status of at least one of the one or more second battery, and the load balancing plan associated with the local device and at least one of the one or more external devices.

11. The apparatus according to claim 9, further including a communications port to communicate power control information with at least one of the one or more external devices, wherein the power control information includes one or more of the charge status of the first battery, the charge status of the one or more second battery, and the load balancing plan.

12. The apparatus according to claim 9, further including a battery measurement module to determine the battery status for the first battery.

13. The apparatus according to claim 9, wherein the charging output comprises one or more of an external power connector, a USB connector, Universal Serial Bus connector, an inductive power charger, a wireless resonant energy link, and a DC-DC converter.

14. The apparatus according to claim 10, wherein the controller further authenticates at least one of the one or more external devices.

15. The apparatus according to claim 10, wherein the controller balances loads between at least two of the one or more external devices.

16. The apparatus according to claim 10, wherein the controller employs at least one load balancing profile.

17. The apparatus according to claim 9, wherein one or more of the charging output, the battery input, and the communications port are integrated.

18. A method comprising:
receiving a power discharge from a first battery of a local device;
generating a controllable charge signal based on the power discharge, a charge status of the first battery, a charge status of a second battery of an external device, and a load balancing plan associated with the local device and an external device; and
routing the charge signal to the external device.

19. The method of claim 18, further including sharing power control information with the external device, wherein the power control information includes one or more of the charge status of the first battery, the charge status of the second battery, and the load balancing plan.

20. The method of claim 19, wherein the power control information is communicated with the external device on a periodic basis.

21. The method of claim 18, wherein the charge signal is routed through one or more of an external power connector, a Universal Serial Bus connector, an inductive power charger, a wireless resonant energy link, and a DC-DC converter.

22. The method of claim 18, further including authenticating the external device.

23. The method of claim 18, further including:
generating a plurality of controllable charge signals; and
routing the plurality of charge signals to a corresponding plurality of external devices in accordance with the load balancing plan.

24. The method of claim 18, further including:
receiving a charge signal from the external device; and
routing the charge signal from the external device to the first battery in accordance with the load balancing plan.

25. A non-transitory computer readable medium comprising a set of instructions which, if executed by a processor cause a local device to:
receive a power discharge from a first battery of the local device;
generate a controllable charge signal based on the power discharge, a charge status of the first battery, a charge status of a second battery of an external device, and a load balancing plan associated with the local device and an external device; and
route the charge signal to the external device.

26. The medium of claim 25, wherein the instructions, if executed, cause a the local device to communicate power control information with the external device, wherein the power control information includes one or more of the charge status of the first battery, the charge status of the second battery, and the load balancing plan.

27. The medium of claim 26, wherein the power control information is to be communicated with the external device on a periodic basis.

28. The medium of claim 25, wherein the charge signal is to be routed through one or more of an external power connector, a Universal Serial Bus connector, an inductive power charger, a wireless resonant energy link, and a DC-DC converter.

29. The medium of claim 25, wherein the instructions, if executed, cause the local device to authenticate the external device.

30. The medium of claim 25, wherein the instructions, if executed, cause the local device to:
generate a plurality of controllable charge signals; and
route the plurality of charge signals to a corresponding plurality of external devices in accordance with the load balancing plan.

31. The medium of claim 25, wherein the instructions, if executed, cause the local device to:
receive a charge signal from the external device; and
route the charge signal from the external device to the first battery in accordance with the load balancing plan.
